(19) United States
(12) Patent Application Publication
(10) Pub. No.: US 2023/0235859 A1
(43) Pub. Date: Jul. 27, 2023

(54) MOBILE LIQUID HYDROGEN REFUELING STATION

(71) Applicant: HyDaaS Inc., Englewood, NJ (US)

(72) Inventor: Steven KIM, Englewood, NJ (US)

(21) Appl. No.: 18/101,186

(22) Filed: Jan. 25, 2023

Related U.S. Application Data
(60) Provisional application No. 63/302,760, filed on Jan. 25, 2022.

(51) Int. Cl. F17C 13/08

(52) U.S. Cl. CPC F17C 13/085; F17C 2221/012; F17C 2270/0105; F17C 2270/0168

(57) ABSTRACT

A mobile liquid hydrogen refueling station which has capabilities of carrying a liquid hydrogen tank assembly securely and loading or unloading the liquid hydrogen tank assembly from the vehicle to the ground, and vice versa, and a liquid hydrogen tank assembly with wheels, so that it can be moved to right next the boat for refueling on top of the shipping dock.

### CROSS-REFERENCE TO RELATED APPLICATION

This application claims priority to U.S. Provisional Pat. Application No. 63/302,760, filed on Jan. 25, 2022, which is hereby incorporated by reference in its entirety.

### BACKGROUND

### Field of the Disclosure

The present disclosure relates to a mobile liquid hydrogen refueling station.

### Description of the Background

Hydrogen fuel cell mobilities such as a ground vehicle and a drone have been popular and commercialized. The hydrogen fuel cell ship or boat are currently being developed.

However, in order to be commercially viable, it needs to have a refueling capability of hydrogen at shipping dock. It is practically not possible to build a hydrogen refueling station at each shipping dock.

A mobile hydrogen refueling station is necessary for the hydrogen fuel cell ship. In order to minimize the volume of the hydrogen tank on the ship, a liquid hydrogen tank for the ship is recommended. Also, the requirement of the high pressure compressor for hydrogen gas refueling system makes difficult for hydrogen gas refueling.

### SUMMARY

The present disclosure is directed to a mobile liquid hydrogen refueling method for ship that substantially obviates one or more of problems due to limitations and disadvantages of the prior art.

More specifically, the present disclosure is to provide a mobile liquid hydrogen refueling station that the ship users can easily refuel the liquid hydrogen next to the ship at the shipping dock.

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and in accordance with the present disclosure, as embodied and broadly described, A mobile liquid hydrogen refueling method, comprise a vehicle transporting or pulling the ship configured to carry the liquid hydrogen refueling tank assembly safely; the liquid hydrogen tank assembly configured to have a mechanism of easily loading and unloading from the vehicle; the liquid hydrogen tank assembly configured to be movable right next to the boat at the shipping dock.

The liquid hydrogen tank assembly includes wheels to move easily not only loading and unloading the liquid hydrogen tank assembly from the vehicle to the ground but also moving to the closest site for the refueling to the ship on the shipping dock as shown in FIGS. 2.

The liquid hydrogen tank assembly is configured to lock it on top of the vehicle while the vehicle is moving.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain the principle of the disclosure.

In the drawings:

FIG. 1A is a schematic view illustrating a vehicle in motion with wheels at a guide bar is locked according to the present disclosure;

FIG. 1B is a schematic view illustrating a loading slide is opened and a guide lock for the wheels is unlocked when unloading a cage according to the present disclosure;

FIG. 1C is a schematic view illustrating a power pulling chain is in use when the cage is unloaded;

FIG. 1D is a schematic view illustrating the cage with a liquid hydrogen tank assembly can be rolled to the dock site;

FIG. 2A is a schematic view illustrating a vehicle pulling boat is carrying the liquid hydrogen tank assembly;

FIG. 2B is a schematic view illustrating the liquid hydrogen tank assembly is refueling the boat at the shipping dock according to the present disclosure; and

FIG. 3 is a view showing the vehicle carrying the liquid hydrogen tank assembly according to the present disclosure.

### DETAILED DESCRIPTION

Reference will now be made in detail to the aspects of the present disclosure, examples of which are illustrated in the accompanying drawings. Wherever possible, the same reference numbers will be used throughout the drawings to refer to the same or like parts.

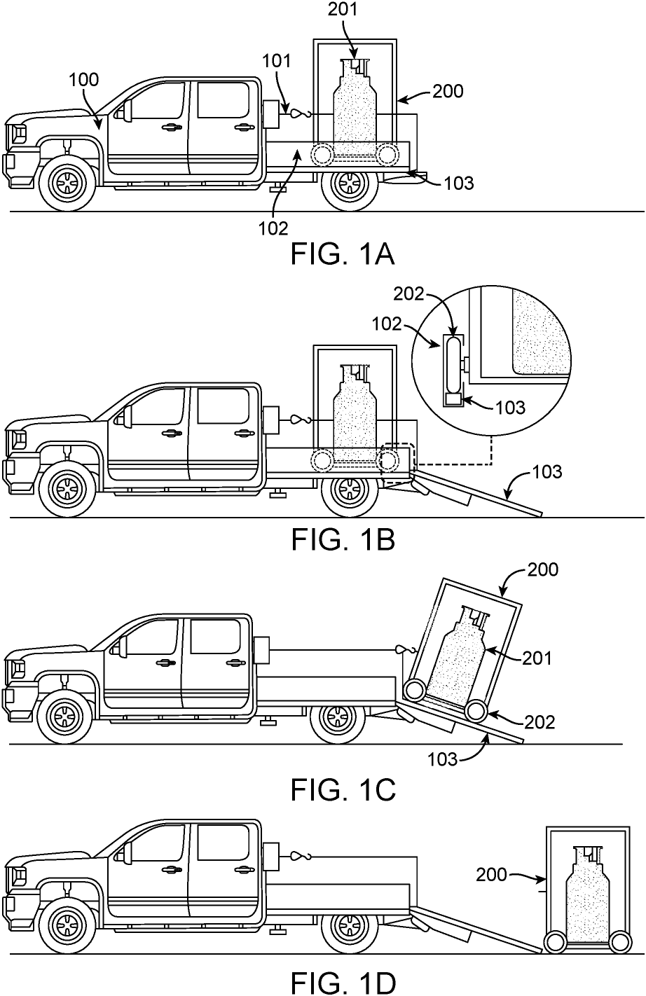

The present disclosure is to provide a method of refueling hydrogen fuel cell ship by using a mobile liquid hydrogen refueling station (100). In order to ensure the safety, a liquid hydrogen tank assembly (200) securely locked by a hook (101) and a wheel guard (102) on top of the vehicle as shown in FIGS. 1A-1D.

FIG. 1A is a schematic view illustrating a vehicle in motion with wheels at a guide bar is locked according to the present disclosure. FIG. 1B is a schematic view illustrating a loading slide is opened and a guide lock for the wheels is unlocked when unloading a cage according to the present disclosure. FIG. 1C is a schematic view illustrating a power pulling chain is in use when the cage is unloaded. FIG. 1D is a schematic view illustrating the cage with a liquid hydrogen tank assembly can be rolled to the dock site;

More specifically, the liquid hydrogen tank assembly can be loaded or unloaded on wheel guide tracks (102) and (103). The wheel guide track (103) can be inserted into the wheel guide track (102) while the liquid hydrogen tank assembly is on top of the vehicle as shown in FIGS. 1A-1D.

The liquid hydrogen tank assembly (200) has a mechanical powered hook (101), so that the tank assembly (200) can be easily loaded or unloaded from the vehicle to the ground, and vice versa.

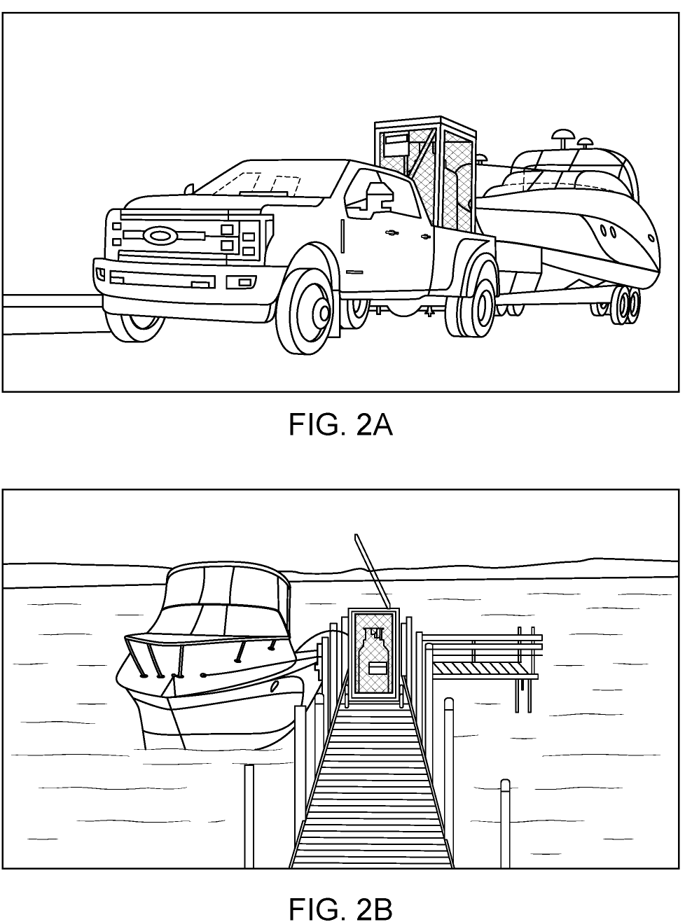

FIG. 2A is a schematic view illustrating a vehicle pulling boat is carrying the liquid hydrogen tank assembly, and FIG. 2B is a schematic view illustrating the liquid hydrogen tank assembly is refueling the boat at the shipping dock according to the present disclosure.

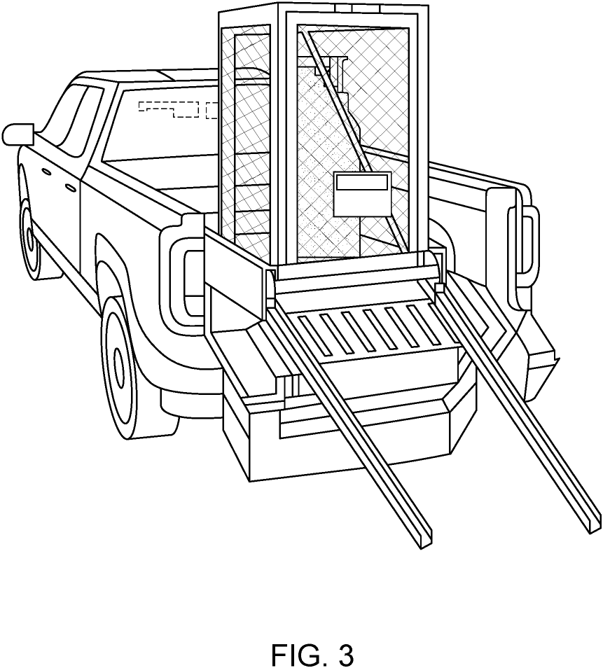

FIG. 3 is a view showing the vehicle carrying the liquid hydrogen tank assembly according to the present disclosure.

It will be apparent to those skilled in the art that various modifications and variations can be made in the mobile drone communication and control station of the present disclosure without departing from the spirit or scope of the aspects. Thus, it is intended that the present disclosure covers the modifications and variations of the aspects provided they come within the scope of the appended claims and their equivalents.

What is claimed is:

1. A mobile liquid hydrogen refueling station, comprising:
a liquid hydrogen tank assembly configured to have wheels that moves the liquid hydrogen tank assembly next to the ship for refueling;
a mechanical powered hook configured to load or unload the liquid hydrogen tank assembly and lock the liquid hydrogen tank assembly while vehicle is moving; and
a wheel guard trail configured to securely load or unload the liquid hydrogen tank assembly.
